(19) United States
(12) Patent Application Publication
(10) Pub. No.: US 2025/0361772 A1
(43) Pub. Date: Nov. 27, 2025

(54) LATCH FOR A LADDER EXTENSION

(71) Applicant: Pure Safety Group, Inc., Pasadena, TX (US)

(72) Inventors: Andrew M. Pass, Bicester (GB); Jordan Andrews-Rogers, Kent (GB)

(73) Assignee: Pure Safety Group, Inc., Pasadena, TX (US)

(21) Appl. No.: 19/179,069

(22) Filed: Apr. 15, 2025

Related U.S. Application Data
(60) Provisional application No. 63/651,214, filed on May 23, 2024.

(51) Int. Cl. E06C 7/18; E06C 7/50

(52) U.S. Cl. CPC E06C 7/182; E06C 7/50

(57) ABSTRACT

A latch for a ladder extension, which has a base configured and arranged to fit over a distal end portion of a side rail of a ladder proximate a rung, comprises a connector, a mounting plate, and a biasing member. The connector has a connecting portion configured and arranged to operatively connect to the base in a fixed position and has a securing end. The mounting plate is configured and arranged to be slidably connected to the base and is slidable between a locked position and an unlocked position relative to the rung. A tab is operatively connected to the mounting plate proximate an opposing end relative to the connector. The biasing member is captured between the securing end of the connector and the tab of the mounting plate, the biasing member biasing the mounting plate into the locked position.

### CROSS-REFERENCE TO RELATED APPLICATIONS

This application claims the benefit of U.S. Provisional Patent Application Ser. No. 63/651,214, filed May 23, 2024, which is incorporated herein by reference in its entirety.

### BACKGROUND

Ladder extensions or walkthrough assemblies are commonly connected to top portions of ladders and extend generally upwardly therefrom, typically one extension extending upwardly from each side rail, allowing users to hold onto them for support while moving between them when transitioning between tops of ladders and support surfaces (e.g., roofs). It is important that such ladder extensions or walkthrough assemblies be securely connected, and installation of such ladder extensions or walkthrough assemblies can be cumbersome or complicated.

For these and other reasons, a need exists for the present invention.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a latch for a ladder extension, which has a base configured and arranged to fit over a distal end portion of a side rail of a ladder proximate a rung, comprises a connector, a mounting plate, and a biasing member. The connector has a connecting portion and a securing end. The connecting portion is configured and arranged to operatively connect to the base of the ladder extension in a fixed position relative to the base. The mounting plate is configured and arranged to slidably connect to the base of the ladder extension and is slidable relative to the base and the connector. The mounting plate is slidable between a locked position and an unlocked position relative to the rung. A tab is operatively connected to the mounting plate proximate an opposing end relative to the connector. The biasing member is captured between the securing end of the connector and the tab of the mounting plate, and the biasing member biases the mounting plate into the locked position.

In one embodiment, a ladder extension assembly comprises a base, a connector, a mounting plate, and a biasing member. The base is configured and arranged to fit over a distal end portion of a side rail of a ladder proximate a rung, and the base includes a slot configured and arranged to receive the rung of the ladder. The connector has a connecting portion and a securing end. The connecting portion is configured and arranged to operatively connect to the base of the ladder extension in a fixed position relative to the base. The mounting plate is configured and arranged to slidably connect to the base of the ladder extension and is slidable relative to the base and the connector. The mounting plate is slidable between a locked position and an unlocked position relative to the rung. A tab is operatively connected to the mounting plate proximate an opposing end relative to the connector. The biasing member is captured between the securing end of the connector and the tab of the mounting plate, and the biasing member biases the mounting plate into the locked position.

In one embodiment, a ladder extension assembly is installed on a ladder having side rails supporting a rung by obtaining the ladder extension assembly comprising a base, a connector, a mounting plate, and a biasing member. The base is configured and arranged to fit over a distal end portion of one of the side rails of the ladder proximate the rung, and the base includes a slot configured and arranged to receive the rung of the ladder. The connector has a connecting portion and a securing end. The connecting portion is configured and arranged to operatively connect to the base of the ladder extension in a fixed position relative to the base. The mounting plate is configured and arranged to slidably connect to the base of the ladder extension and is slidable relative to the base and the connector. The mounting plate is slidable between a locked position and an unlocked position relative to the rung. A tab is operatively connected to the mounting plate proximate an opposing end relative to the connector. The biasing member is captured between the securing end of the connector and the tab of the mounting plate, and the biasing member biases the mounting plate into the locked position. The base is slid over the distal end portion of the side rail of the ladder, with the slot receiving the rung of the ladder, and the mounting plate contacts the rung thereby moving the mounting plate toward the unlocked position. The mounting plate is moved past the rung and the biasing member biases the mounting plate back into the locked position thereby positioning the rung between the base and the mounting plate to prevent the base from being moved off the side rail.

### BRIEF DESCRIPTION OF THE DRAWINGS

FIG. 1 is a perspective view of a ladder extension assembly operatively connected to a ladder.

FIG. 2 is a partially exploded perspective view of an extension portion of the ladder extension assembly shown in FIG. 1.

FIG. 2A is an exploded perspective view of a latch assembly of the extension portion shown in FIG. 2.

FIG. 3 is a front view of the ladder extension assembly operatively connected to the ladder shown in FIG. 1.

FIG. 4 is a cross-section view of the ladder extension assembly operatively connected to the ladder taken along the lines 4-4 in FIG. 3 showing the latch assembly in a locked position.

FIG. 4A is an enlarged view of the latch assembly in the locked position shown in FIG. 4.

FIG. 5 is a is a cross-section view of the ladder extension assembly operatively connected to the ladder taken along the lines 5-5 in FIG. 3 showing the latch assembly in an unlocked position.

FIG. 5A is an enlarged view of the latch assembly in the unlocked position shown in FIG. 5.

FIG. 6 is a front perspective view of alternative embodiments of a mounting plate and a housing that could be used with the latch assembly shown in FIG. 2A.

FIG. 7 is an exploded front perspective view of the mounting plate and the housing shown in FIG. 6.

FIG. 8 is an exploded rear perspective view of the mounting plate and the housing shown in FIG. 6.

FIG. 9 is an exploded front perspective view of an alternative embodiment latch assembly that could be used with the ladder extension assembly shown in FIG. 1.

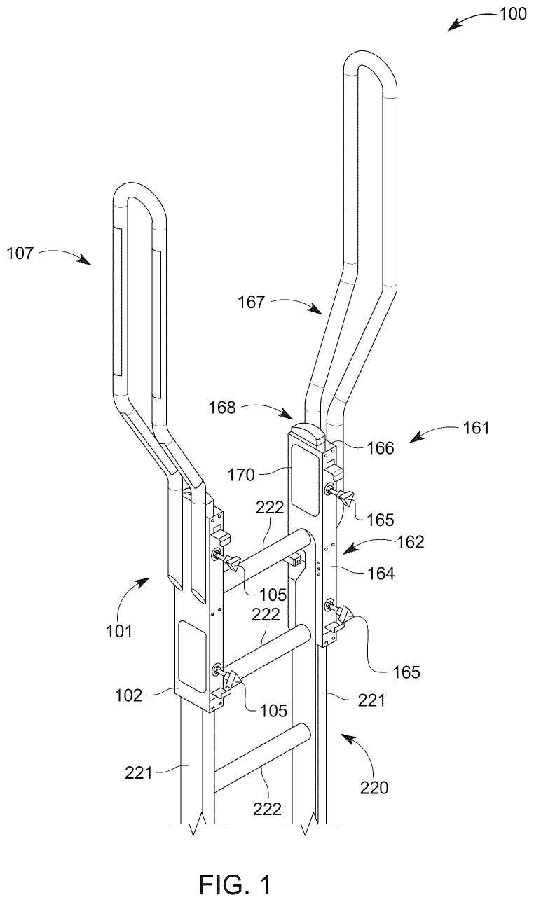

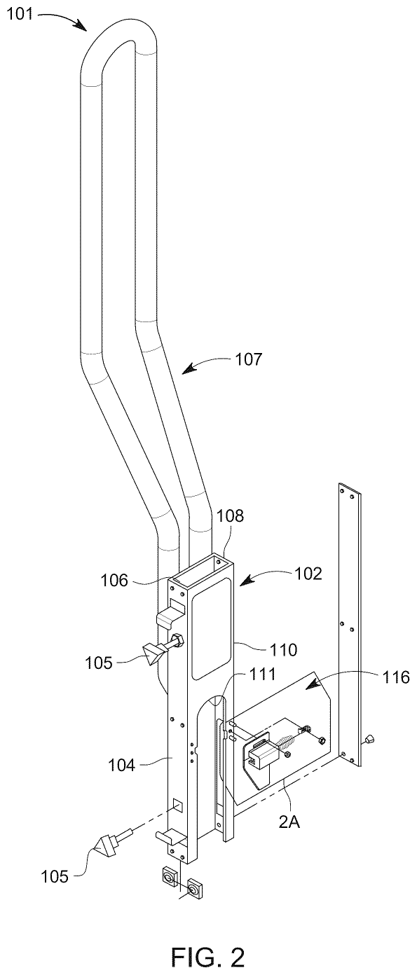

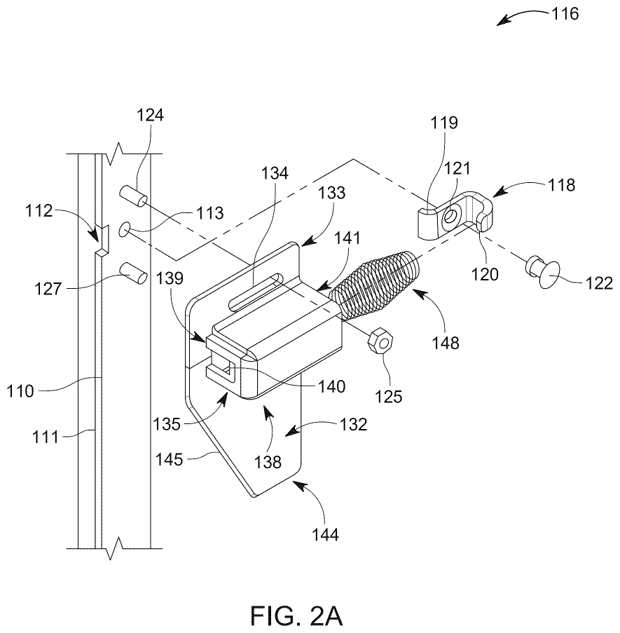

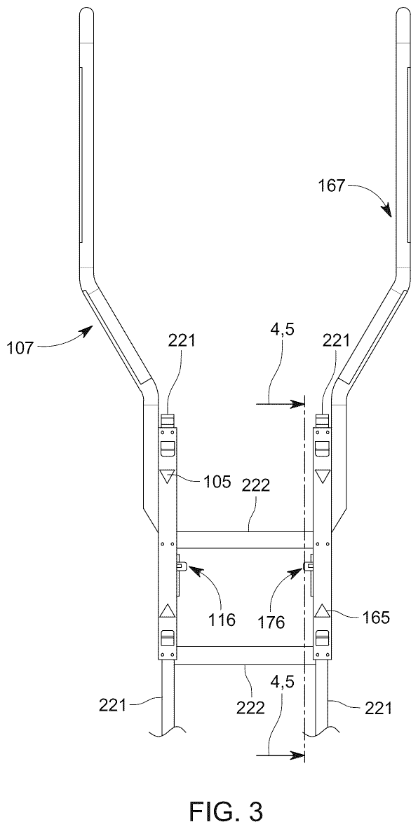

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Generally, latch assembly embodiments include a mounting plate slidable relative to a base configured and arranged to fit over a distal end portion of a ladder side rail proximate a rung. The mounting plate is slidable between a locked position and an unlocked position relative to the rung. Preferably, a biasing member biases the mounting plate into the locked position.

An embodiment ladder extension assembly 100 includes a first extension 101 and a second extension 161 providing a walkthrough therebetween to assist a user in transitioning between a ladder and a support structure (e.g., a roof, not shown). Although embodiments are shown and described as including first and second extensions, it is recognized that a single extension could be used. A latch assembly could be used with an extension used singly or as a pair.

The first extension 101includes a base 102, which is like a sleeve that fits over and receives a distal end portion of a side rail 221 of a ladder 220 proximate a rung 222. The base 102 includes a front 104, a first side 106, a rear 108, and a second side 110 forming a generally rectangular channel configured and arranged to receive the distal end portion of the side rail 221. The front 104 could include knob(s) 105 configured and arranged to provide friction with the rear 108 and the knob(s) 105 against the distal end portion. The first side 106 could include a railing 107 extending upwardly therefrom. The second side 110 could include a slot 111 configured and arranged to receive rung(s) 222. Preferably, a top portion of the slot 111 is configured and arranged to contact a rung 222. Optionally, a bottom portion of the slot 111 receives another rung 222. Preferably, opposing sides of the slot 111 include notches 112, and apertures 113 are beside the notches 112. Although notches 112 and apertures 113 are shown and described as being on opposing sides of the slot 111, which assists in more efficient manufacturing, it is recognized that only one side of the slot could include a notch 112 and an aperture 113. Preferably, a first protrusion 124 extends outward from the base 102 above the aperture 113, and a second protrusion 127 extends outward from the base 102 below the aperture 113.

A latch assembly 116 includes a connector 118 configured and arranged to be operatively connected to the base 102 with a first end 119 (engaging end) fitting within the notch 112, a second end 120 (securing end) extending outwardly from the base 102, and an aperture 121 aligning with the aperture 113 of the base 102. A connecting portion includes the first end 119 and the portion including the aperture 121. A fastener 122 extends through the apertures 121 and 113 to connect the connector 118 to the base 102. Other suitable connectors could be used.

A mounting plate 132 is generally rectangular-shaped with one bottom corner removed to form an angled surface 145. A top portion 133 includes a housing 138 positioned horizontally between a first slot 134 and a second slot 135. In this embodiment, the housing 138 is integral with the mounting plate 132. The housing 138 includes a first end 139, which forms a tab 140 extending inwardly within a cavity formed by the mounting plate 132 and the housing 138 in this embodiment, but it is recognized that the mounting plate 132 could form a tab. A second end 141 of the housing 138 forms an opening (not shown) into the cavity. A bottom portion 144 of the mounting plate 132, including the angled surface 145, extends downward from the top portion 133.

The first protrusion 124 of the base 102 extends through the first slot 134 of the mounting plate 132, and the second protrusion 127 of the base 102 extends through the second slot 135 of the mounting plate 132. A first nut 125 is threaded onto the first protrusion 124 and a second nut 128 is threaded onto the second protrusion 127 to slidably secure the mounting plate 132 onto the base 102. Because the first and second protrusions 124 and 127 extend through the first and second slots 134 and 135, the mounting plate 132 is slidable relative to the base 102.

A biasing member 148, which is preferably a compression spring in this embodiment, is positioned within the cavity with the tab 140 extending into one end and the second end 120 of the connector 118 extending into the other end.

Similar to the first extension 101, the second extension 161 is generally a mirror image of the first extension 101 and includes a base 162, which is like a sleeve that fits over and receives a distal end portion of a side rail 221 of a ladder 220 proximate a rung 222. The base 162 includes a front 164, a first side 166, a rear 168, and a second side 170 forming a generally rectangular channel configured and arranged to receive the distal end portion of the side rail 221. The front 164 could include knob(s) 165 configured and arranged to provide friction with the rear 168 and the knob(s) 165 against the distal end portion. The first side 166 could include a railing 167 extending upwardly therefrom. The second side 170 could include a slot 171 configured and arranged to receive rung(s) 222. Preferably, a top portion of the slot 171 is configured and arranged to contact a rung 222. Optionally, a bottom portion of the slot 171 receives another rung 222. Preferably, opposing sides of the slot 171 include notches 172, and apertures 173 are beside the notches 172. Although notches 172 and apertures 173 are shown and described as being on opposing sides of the slot 171, which assists in more efficient manufacturing, it is recognized that only one side of the slot could include a notch 172 and an aperture 173. Preferably, a first protrusion 184 extends outward from the base 162 above the aperture 173, and a second protrusion 187 extends outward from the base 162 below the aperture 173.

A latch assembly 176 includes a connector (not shown) configured and arranged to be operatively connected to the base 162 with a first end 179 (engaging end) fitting within the notch 172, a second end (securing end, not shown) extending outwardly from the base 162, and an aperture (not shown) aligning with the aperture 173 of the base 162. A connecting portion includes the first end 179 and the portion including the aperture. A fastener (not shown) extends through the apertures to connect the connector to the base 162. Other suitable connectors could be used.

A mounting plate 192 is generally rectangular-shaped with one bottom corner removed to form an angled surface 205. A top portion 193 includes a housing 198 positioned horizontally between a first slot 194 and a second slot 195. Optionally, there can be a slot 196 between the first and second slots 194 and 195. In this embodiment, the housing 198 is integral with the mounting plate 192. The housing 198 includes a first end 199, which forms a tab 200 extending inwardly within a cavity formed by the mounting plate 192 and the housing 198 in this embodiment, but it is recognized that the mounting plate 192 could form a tab. A second end 201 of the housing 198 forms an opening 202 into the cavity. A bottom portion 204 of the mounting plate 192, including the angled surface 205, extends downward from the top portion 193.

The first protrusion 184 of the base 162 extends through the first slot 194 of the mounting plate 192, and the second protrusion 187 of the base 162 extends through the second slot 195 of the mounting plate 192. A first nut 185 is threaded onto the first protrusion 184 and a second nut 188 is threaded onto the second protrusion 187 to slidably secure the mounting plate 192 onto the base 162. Because the first and second protrusions 184 and 187 extend through the first and second slots 194 and 195, the mounting plate 192 is slidable relative to the base 162.

A biasing member 208, which is preferably a compression spring in this embodiment, is positioned within the cavity, and optionally partially within the slot 196, with the tab 200 extending into one end and the second end of the connector extending into the other end.

Although the first and second extensions 101 and 161 operate independently and can be used either together or separately, in this embodiment they operate similarly and, therefore, will be described together.

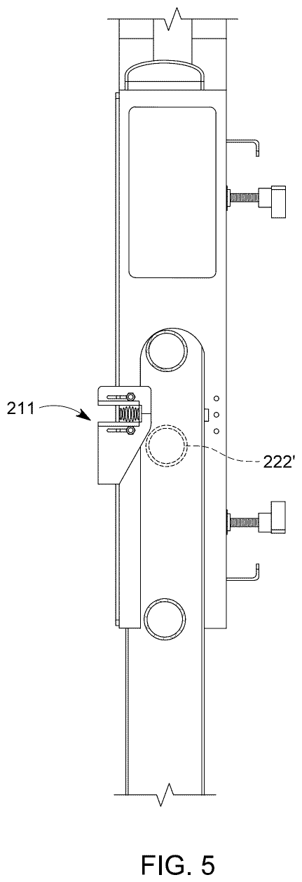

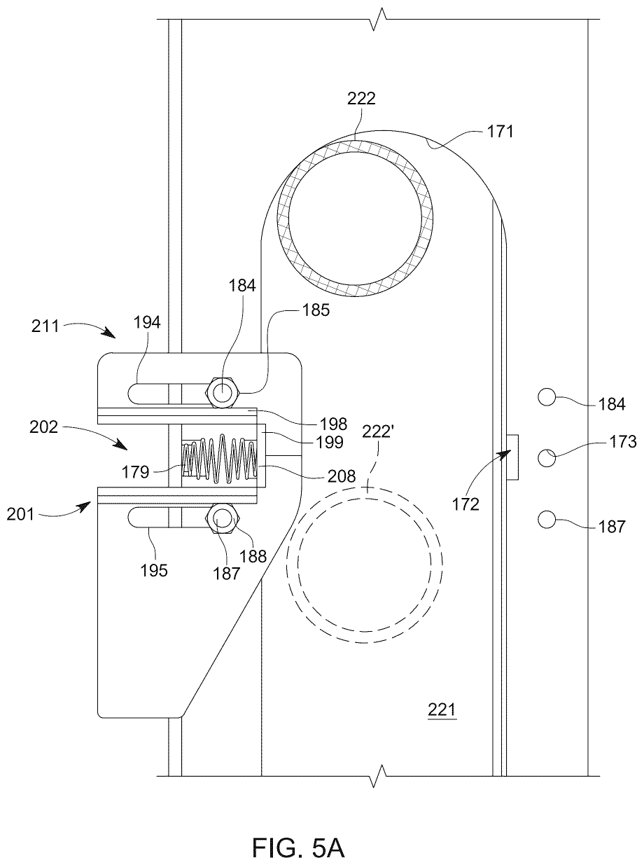

In operation, during installation on a ladder, the latch assembly 116 or 176 is generally automatic, meaning the user only needs to position the base 102 or 162 onto the ladder side rail 221. The angled surface 145 or 205 contacts the rung 222 as an upward pressure is exerted on the mounting plate 132 or 192 by the rung 222 as a downward pressure is exerted on the base 102 or 162, compressing the biasing member 148 or 208, which causes the mounting plate 132 or 192 to slide toward and into the unlocked position 211. A rung 222′ is drawn in phantom lines in FIGS. 5 and 5A to illustrate the mounting plate 132 or 192 relative to a rung as it moves past the rung. When the rung passes the mounting plate 132 or 192, the biasing member 148 or 208 exerts force against the mounting plate 132 or 192 to return the mounting plate 132 or 192 into the locked position 210.

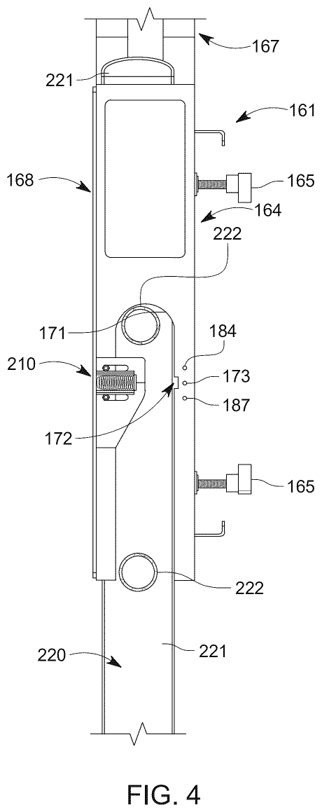

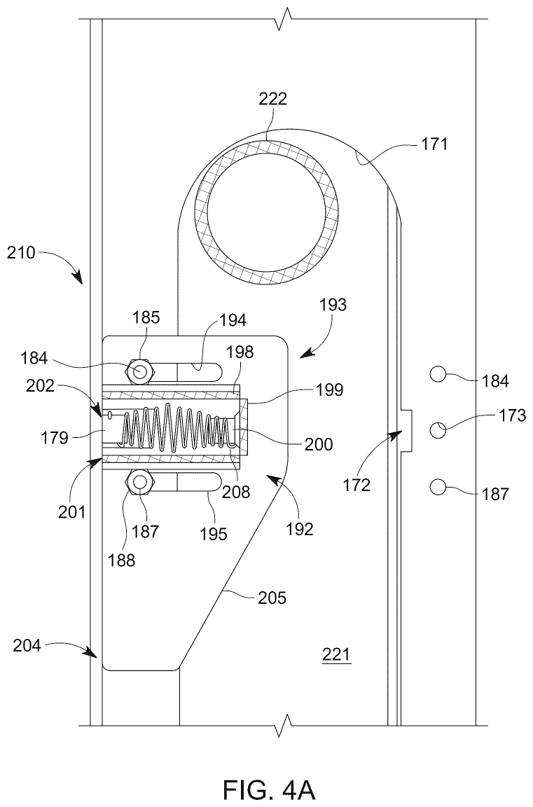

After installation, because the connector 118 is fixed relative to the base 102 or 162, the biasing member 148 or 208 places a biasing force on the mounting plate 132 or 192 and the mounting plate 132 or 192 is biased in a locked position 210. The locked position 210 is shown in FIGS. 4 and 4A. The force of the biasing member 148 or 208 can be overcome by manually sliding the mounting plate 132 or 192, thereby compressing the biasing member 148 or 208, and moving the mounting plate 132 or 192 toward and into an unlocked position 211. The unlocked position 211 is shown in FIGS. 5 and 5A. The locked position 210 prevents removal of the base 102 or 162 from the distal end portion of the ladder's side rail 221 because the mounting plate 132 or 192 extends into the slot 111 or 171 and contacts the rung 222, acting as a stop. In the unlocked position 211, the mounting plate 132 or 192 is slid to sufficiently clear the slot 111 or 171 and allow passage of the rung 222 past the mounting plate 132 or 192.

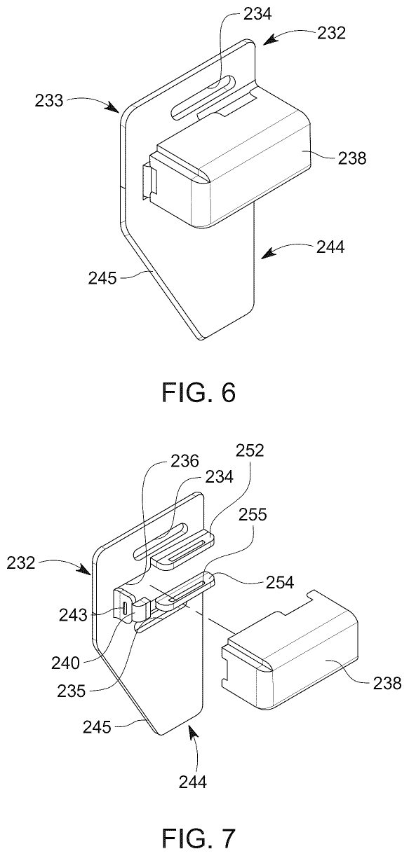

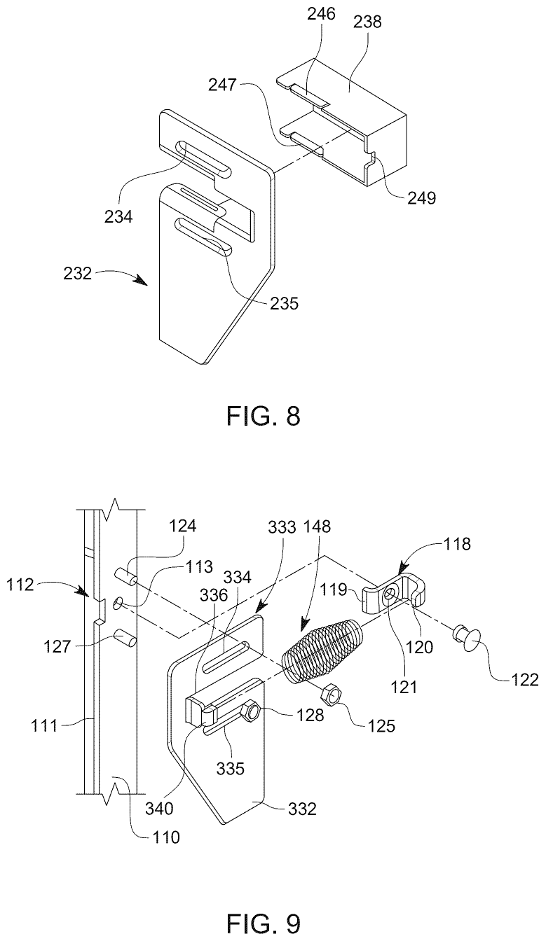

Alternatively, as a substitute for the mounting plate 192 (or a mirror image for mounting plate 132), a mounting plate 232 could be used. Mounting plate 232 is shown in FIGS. 6-8. Some of the features of mounting plate 232 are similar to those of mounting plate 192 and, therefore, only significant differences are being described. The mounting plate 232 includes a top portion of 233 with an intermediate slot 236 positioned between a top slot 234 and a bottom slot 235. Preferably, the intermediate slot 236 is formed by cutting (e.g. laser cutting) a top extension 252, a bottom extension 254, and a tab 240 in the mounting plate 323 between the top and bottom slots 234 and 235 and bending them to extend outward thereby forming the intermediate slot 236. The top extension 252 includes a slot 253, the bottom extension 254 includes a slot 255, and the tab 240 is bent upward and inward. The upward extending portion of the tab 240 includes a slot 243. A bottom portion 244 of the mounting plate 232 includes an angled portion 245.

A separate housing 238 includes extensions 246 and 247 configured and arranged to be inserted into the slots 234 and 235 and a tab 249 configured and arranged to be inserted into the slot 243 to connect the housing to the mounting plate 232. The biasing member (not shown) is engaged by the tab 240 of the mounting plate 232 and the connector.

Alternatively, as a substitute for the mounting plate 192 (or a mirror image for mounting plate 132), a mounting plate 332 could be used. Mounting plate 332 is shown in FIG. 9. Some of the features of mounting plate 332 are similar to those of mounting plates 192 and 232 and, therefore, only significant differences are being described. The mounting plate 332 includes a top portion of 333 with an intermediate slot 336 positioned between a top slot 334 and a bottom slot 335. Preferably, the intermediate slot 336 is formed by cutting (e.g. laser cutting) a tab 340 in the mounting plate 332 between the top and bottom slots 334 and 335, removing some of the material to form an opening into the slot 336, and bending the tab 340 to extend upward and inward relative to the slot 336. The biasing member is engaged by the tab 340 of the mounting plate 332 and the connector 118. A bottom portion 244 of the mounting plate 232 includes an angled portion 245. This embodiment does not include a housing.

It is to be understood that the features of the various exemplary embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A latch for a ladder extension, the ladder extension having a base configured and arranged to fit over a distal end portion of a side rail of a ladder proximate a rung, comprising:
a connector having a connecting portion and a securing end, the connecting portion configured and arranged to operatively connect to the base of the ladder extension in a fixed position relative to the base;
a mounting plate configured and arranged to slidably connect to the base of the ladder extension and being slidable relative to the base and the connector, the mounting plate being slidable between a locked position and an unlocked position relative to the rung, a tab being operatively connected to the mounting plate proximate an opposing end relative to the connector; and
a biasing member being captured between the securing end of the connector and the tab of the mounting plate, the biasing member biasing the mounting plate into the locked position.

2. The latch of claim 1, wherein the connecting portion has an aperture configured and arranged to receive a fastener for connecting the connecting portion to the base.

3. The latch of claim 1, wherein the connecting portion has an engaging end configured and arranged to engage the base of the ladder extension.

4. The latch of claim 1, wherein the biasing member is a compression spring captured between the securing end of the connector and the tab of the mounting plate.

5. The latch of claim 4, wherein the compression spring is compressed in the unlocked position and biases the mounting plate in the locked position.

6. The latch of claim 1, further comprising a housing, the biasing member being positioned between opposing sides formed by the mounting plate and the housing.

7. The latch of claim 6, wherein the mounting plate and the housing are integral.

8. The latch of claim 6, wherein the mounting plate and the housing are separate components operatively connected.

9. The latch of claim 6, wherein the housing includes the tab.

10. The latch of claim 1, wherein the mounting plate includes the tab.

11. The latch of claim 1, wherein the mounting plate includes an angled surface configured and arranged to cause the mounting plate to move toward the unlocked position when the rung contacts the angled surface as the ladder extension is positioned on the side rail.

12. A ladder extension assembly, comprising:
a base configured and arranged to fit over a distal end portion of a side rail of a ladder proximate a rung, the base including a slot configured and arranged to receive the rung of the ladder;
a connector having a connecting portion and a securing end, the connecting portion configured and arranged to operatively connect to the base of the ladder extension in a fixed position relative to the base;
a mounting plate configured and arranged to slidably connect to the base of the ladder extension and being slidable relative to the base and the connector, the mounting plate being slidable between a locked position and an unlocked position relative to the rung, a tab being operatively connected to the mounting plate proximate an opposing end relative to the connector; and
a biasing member being captured between the securing end of the connector and the tab of the mounting plate, the biasing member biasing the mounting plate into the locked position.

13. The latch of claim 12, wherein the connecting portion has an aperture configured and arranged to receive a fastener for connecting the connecting portion to the base.

14. The latch of claim 12, wherein the connecting portion has an engaging end configured and arranged to engage the base of the ladder extension.

15. The latch of claim 12, wherein the biasing member is a compression spring captured between the securing end of the connector and the tab of the mounting plate.

16. The latch of claim 15, wherein the compression spring is compressed in the unlocked position and biases the mounting plate in the locked position.

17. The latch of claim 12, further comprising a housing, the biasing member being positioned between opposing sides formed by the mounting plate and the housing.

18. The latch of claim 17, wherein the mounting plate and the housing are integral.

19. The latch of claim 17, wherein the mounting plate and the housing are separate components operatively connected.

20. The latch of claim 12, wherein the mounting plate includes an angled surface configured and arranged to cause the mounting plate to move toward the unlocked position when the rung contacts the angled surface as the ladder extension is positioned on the side rail.

21. A method of installing a ladder extension assembly on a ladder having side rails supporting a rung, comprising:
obtaining a ladder extension assembly comprising a base, a connector, a mounting plate, and a biasing member, the base configured and arranged to fit over a distal end portion of one of the side rails of the ladder proximate the rung, the base including a slot configured and arranged to receive the rung of the ladder, the connector having a connecting portion and a securing end, the connecting portion configured and arranged to operatively connect to the base of the ladder extension in a fixed position relative to the base, the mounting plate configured and arranged to slidably connect to the base of the ladder extension and being slidable relative to the base and the connector, the mounting plate being slidable between a locked position and an unlocked position relative to the rung, a tab being operatively connected to the mounting plate proximate an opposing end relative to the connector, the biasing member being captured between the securing end of the connector and the tab of the mounting plate, the biasing member biasing the mounting plate into the locked position;
sliding the base over the distal end portion of the side rail of the ladder, the slot receiving the rung of the ladder;
contacting the mounting plate with the rung thereby moving the mounting plate toward the unlocked position;
moving the mounting plate past the rung, the biasing member biasing the mounting plate back into the locked position thereby positioning the rung between the base and the mounting plate to prevent the base from being moved off the side rail.

22. The method of claim 21, wherein the mounting plate is slid into the unlocked position to move the base off the side rail.
